(19) United States
(12) Patent Application Publication
(10) Pub. No.: US 2026/0056063 A1
(43) Pub. Date: Feb. 26, 2026

(54) METHOD FOR DETERMINING THE TEMPERATURE OF THE WATER PRESENT IN A WATER SUPPLY NETWORK, AND DETERMINATION DEVICE FOR DETERMINING SUCH A TEMPERATURE

(71) Applicant: Diehl Metering GmbH, Ansbach (DE)

(72) Inventor: Ulrich Eff, Herrieden (DE)

(21) Appl. No.: 19/304,824

(22) Filed: Aug. 20, 2025

(30) Foreign Application Priority Data
Aug. 20, 2024 (DE) 10 2024 123 710.4
Sep. 2, 2024 (DE) 10 2024 125 000.3

(51) Int. Cl. G01K 3/14; G01K 1/024; G01K 3/10; G01K 13/02

(52) U.S. Cl. CPC G01K 3/14; G01K 1/024; G01K 3/10; G01K 13/026

(57) ABSTRACT

A method determines the temperature of the water present in a water supply network. The water supply network is connected to a point of consumption arranged in a building via a connection apparatus that leads into the building from the outside. The connection apparatus contains a water meter. A piece of quantity information relating to a quantity of water reaching the point of consumption via the connection apparatus is acquired by a quantity detector of the water meter. A piece of temperature information relating to a temperature of the water situated in the region of the water meter is acquired by a temperature detector. Wherein a fulfilment of a save condition is verified, the latter being fulfilled if the quantity information yields that a temperature of the water situated in the region of the water meter corresponds to the temperature of the water present in the water supply network.

### CROSS-REFERENCE TO RELATED APPLICATION

This application claims the priority, under 35 U.S.C. § 119, of German Patent Applications DE 10 2024 123 710.4, filed Aug. 20, 2024, and DE 10 2024 125 000.3, filed Sep. 2, 2024; the prior applications are herewith incorporated by reference in their entireties.

### FIELD AND BACKGROUND OF THE INVENTION

The present invention relates to a method for determining the temperature of the water present in a water supply network. The water supply network is connected to a point of consumption arranged in a building via a connection apparatus that leads into the building from the outside, wherein the connection apparatus contains a water meter that is also arranged in the building.

A typical requirement in relation to the water present in a water supply network, which is frequently used as drinking water, is that its temperature is kept as low as possible. In particular so as to prevent potential contamination with germs, for instance Legionella, the water temperature in the water supply network is typically required not to exceed 25° C. Especially due to the increasingly high temperatures during the summer months, the risk that this requirement can no longer be readily met is growing. Moreover, in recent developments, water pipes in the water supply network are being laid near the ground surface, especially for reasons of cost. For example, higher temperatures on average may typically be expected in the winter months, too, and this has resulted in water pipes frequently being laid at a depth of 0.8-1.0 m on account of the receding risk of icing over and the pipes no longer being laid at a depth of at least 2.0 m, as was typically the case in the past. These circumstances also increase the risk that the specified maximum temperature of the water in the water supply network can no longer be observed on account of correspondingly higher ambient temperatures. Against this background, there is the need of being able to monitor the temperature in the water supply network without gaps where possible.

### SUMMARY OF THE INVENTION

The problem addressed by the present invention is that of specifying an improved concept regarding the determination and monitoring of the temperature of the water present in the water supply network.

According to the invention, in a method of the type set forth at the outset, the problem is solved by virtue of the fact that at least one piece of quantity information relating to a quantity of water reaching the point of consumption via the connection apparatus is acquired by means of a quantity detection means of the water meter. At least one piece of temperature information relating to a temperature of the water situated in the region of the water meter is acquired by means of a temperature detection means. A fulfilment of a save condition is verified, the latter being fulfilled or only being capable of being fulfilled if the quantity information or at least one piece of the quantity information yields that a temperature of the water situated in the region of the water meter corresponds to the temperature of the water present in the water supply network. The at least one piece of currently acquired temperature information is stored in a data memory and/or used to determine the temperature of the water present in the water supply network in the event of the fulfilment of the save condition.

In particular, the present invention overcomes the problem of the water present in the region of the water meter having a temperature that deviates from the temperature of the water present in the water supply network such that the temperature of this water is not suitable for determining the temperature in the water supply network as a matter of principle. For example, water meters are typically located in the interior of buildings. Thus, provided no water is currently drawn from the water supply network via the connection apparatus, and none has been drawn immediately prior, the temperature of the water present in the region of the water meter or within the water meter corresponds to the temperature that is also present in the surroundings of the water meter and consequently present in the building. Consequently, the temperature of the water present in the water meter corresponds to the temperature of the water present in the water supply network only at those times at which the water present in the water meter was still in the region of the water supply network immediately prior. Otherwise, the temperature of the water present in the water meter approaches the prevalent temperature in the surroundings of the water meter over time in accordance with Newton's law of cooling, and so this is not suitable, fundamentally or at first glance, for the determination of the temperature of the water present in the water supply network.

To overcome or circumvent this problem, the invention provides for the verification of the save condition, which is only fulfilled if the quantity information yields or implies that the water currently present in the water meter was still present in the water supply network immediately prior and consequently has a temperature that corresponds to, or only insignificantly deviates from, the temperature there. Thus, the quantity information in particular specifies a value, for instance in cubic meters, which specifies the amount or the mass or the volume of the water that is currently passing through the water meter or that passed through the latter during a measurement interval immediately preceding the current time. If this flow rate is sufficiently high, the assumption can be made that the temperature of the water currently present in the fluid meter corresponds to the temperature of the water present in the water supply network, and so the value for the at least one piece of currently acquired temperature information can be used as a measurement value in this respect. The quantity information that was typically only acquired in the context of billing purposes to date consequently finds additional use within the scope of the present invention to perform a reliable determination of the temperature of the water in the water supply network.

The water supply network should be understood to mean those components, in particular water pipes, by means of which the water from the supplier reaches the respective consumer, i.e. the respective connection apparatus, which in practice is frequently referred to as service connection or connection for short. The water pipes are typically laid underground and have branches, via which the water reaches the respective connection apparatus.

The water meter preferably contains an inlet and an outlet, with the water reaching a measuring chamber or measuring section of the water meter via the inlet on the water supply network side and with the water flowing out of the water meter on the consumer side via the outlet. A connecting means, in particular a connecting flange, may be provided at the inlet and/or the outlet, by means of which the water meter is connected or connectable to the water pipe of the water supply network or a pipe of the connection apparatus.

In order to acquire the at least one piece of quantity information, the water meter contains the at least one quantity detection means, by means of which this information is acquired by measurement. In this respect, the water meter may be designed, by way of example, as an impeller water meter with an impeller that rotates depending on the flow rate or as a volume counter with stationary or movable measuring chamber separating walls or as an ultrasonic meter with a unit for generating ultrasonic beams emitted into the water, on the basis of which the quantity information is ascertained.

The at least one temperature detection means, which is a component of the water meter in particular, is provided to acquire the at least one piece of temperature information. Thus, the temperature detection means may project into the measuring chamber or at least portions thereof may be arranged in the latter. For instance, the temperature-dependent electrical conductivity of a measuring element of the temperature detection means or a parameter dependent thereon is determinable by means of the temperature detection means, which may also be referred to as a thermometer unit. Since the measuring element is in thermal contact with the water, the temperature information is ascertainable on the basis of the corresponding measurement value.

By storing the at least one piece of temperature information in the data memory, the measurement value or the information by means of which the temperature of the water present in the water supply network is determinable is saved. This information can subsequently be read at a later time. The data memory may be a component of an evaluation device. The evaluation device may be configured to perform the method according to the invention, in particular at least to verify the fulfilment of the save condition.

The invention may provide for the save condition to be fulfilled or only capable of being fulfilled if the quantity information or at least one piece of the quantity information yields that an amount of water that has passed through the water meter within a current time interval is greater than a predetermined limit value. The limit value is sufficiently large such that the water currently present in the water meter has a temperature that at least substantially corresponds to the temperature in the water supply network with a great probability, in particular with a probability verging on certainty. Specifically, it is conceivable that the limit value is a fixedly predetermined value. In this case, the limit value may correspond to an amount of water that is greater than the amount of water present in the region of the water meter, in particular present in the measuring chamber or in the connection apparatus. For instance, the save condition is fulfilled or only capable of being fulfilled if the amount of water drawn on the side of the point of consumption, i.e. the amount of water passing through the fluid meter or the connection apparatus, in particular during a period of time, exceeds the limit value.

It is conceivable that the at least one piece of quantity information and/or the at least one piece of temperature information is acquired at predetermined, in particular constant, time intervals. For example, provision can be made for the information to be acquired cyclically, at intervals of a few seconds, for instance two seconds. Thus, the corresponding acquisition may also represent a sufficient dataset for an evaluation in respect of the aforementioned billing purposes. By preference, the save condition is also verified at the predetermined time intervals, in particular cyclically.

It is conceivable that at least one piece of temperature information optionally already stored in the data memory in advance is overwritten by the at least one piece of current temperature information in the event of the fulfilment of the save condition. However, provision is preferably made for the at least one piece of current temperature information to be additionally stored in the event of the fulfilment of the save condition, provided that the at least one piece of temperature information was already stored previously in the data memory, in particular due to the save condition having been fulfilled previously. This improves a dataset, on the basis of which the temperature of the water in the water supply network is verifiable. According to this embodiment, the stored values for the pieces of temperature information form a data record that represents a time series, which can also be referred to as a data history log or a historical data record.

In order to be able to obtain a result that is as robust as possible from the evaluation of the available data in particular, provision can be made for the at least one piece of current quantity information to be stored in the data memory in addition to the at least one piece of current temperature information. Thus, for instance, a result or value for the temperature of the water present in the water supply network may be linked in respect of a measurement accuracy with the respective quantity information. Thus, it is conceivable that an assumed measurement error for the at least one piece of temperature information is greater for smaller respective associated amounts of water determined on the basis of the respective quantity information. Additionally, a possibly present, systematic relationship between the value relating to the temperature of the water present in the water supply network and the amount of water may be taken into account during the corresponding evaluation. Thus, a systematic deviation present in this respect may be assumed to be greater for smaller values of the associated amount of water.

By preference, the invention provides for the connection apparatus, in particular the water meter, to comprise a connection-side transmission device, by means of which a communications link can be established to a user-side transmission device, a supplier-side transmission device in particular, wherein the at least one piece of temperature information stored in the data memory is transmitted within the scope of a readout process from the connection apparatus to the user-side transmission device via the communications link. For example, the water meter is typically read in respect of corresponding consumption data at predetermined time intervals, for instance monthly, for the aforementioned billing purposes. In the process, the stored temperature information is additionally transmitted and consequently provided for further evaluation purposes. A wireless communications link, for instance a radio link, may be established as the communications link. Thus, the connection-side transmission device and the user-side transmission device are or comprise appropriate means that act as transmitter or receiver. Thus, the user-side transmission device may be a component of a reader which, provided the latter is brought sufficiently close to the connection-side transmission device, is configured to call or receive the respective values, which may subsequently be stored and/or output.

It is conceivable that within the scope of the readout process the at least one piece of quantity information, in addition to the at least one piece of temperature information, is transmitted from the connection apparatus to the user-side transmission device via the communications link. As mentioned previously, a measurement error relating to the respective piece of temperature information is determinable on the basis of the quantity information for example, and so the additional transmission of the quantity information enables the use of the quantity information in this way. The provided or called data record consequently preferably contains not only the values relating to the respective time and in this respect the assigned pieces of temperature information but also, in particular, values for the pieces of quantity information assigned to the respective time.

Furthermore, according to the invention it is conceivable that the connection apparatus, in particular the water meter, contains an output device, by means of which the piece of stored temperature information or the pieces of stored temperature information stored in the data memory is or are output. The output device may be or comprise a digital display, wherein analogue output means, such as scales with pointers, may also be provided. Within the scope of this embodiment, it becomes possible to be able to read current values in respect of the at least one piece of temperature information directly by way of the output device, especially if rather than storing the piece of currently captured temperature information, only the determination of the temperature of the water present in the water supply network, implemented on the basis thereof, is provided.

It is conceivable that the at least one piece of temperature information is also used in the context of further purposes or evaluations. Thus, provision is preferably made for the at least one piece of temperature information to be additionally used within the scope of a quantity measurement relating to an overall water consumption. Thus, the current temperature of the water passing through the water meter fundamentally is a parameter that influences values or results in respect of a current consumption, especially since the density, i.e. the mass per unit volume, of the water depends on the temperature of the water.

In addition to that or in an alternative, it is conceivable that the at least one piece of temperature information is additionally used within the scope of realizing a frost protection function. Thus, provision can be made for the fulfilment of a frost condition to be verified, in particular by means of the evaluation device, said frost condition only being fulfilled or capable of being fulfilled if the at least one piece of temperature information yields that the water present in the region of the connection apparatus or of the water meter currently has a temperature at which a current or imminent formation of ice can be expected. Should the frost condition be fulfilled, there may be, in particular by means of the evaluation device, a signal output that is directed to the removal or reduction of this risk. For example, the signal output may cause an output, in particular an acoustic output, of an alert signal to a user, by means of which the latter is informed about this risk. In addition to that or in an alternative, the signal may be output to a heating device, with the water temperature being increased by means of the heating device in this case.

The present invention moreover relates to a determination device for determining the temperature of the water present in a water supply network, wherein the water supply network is connected to a point of consumption arranged in a building via a connection apparatus that leads into the building from the outside, wherein the determination device comprises or is designed as a water meter of the connection apparatus that is also arranged in the building. According to the invention, the problem addressed by the present invention is solved in the context of such a determination device by virtue of the fact that at least one piece of quantity information relating to a quantity of water reaching the point of consumption via the connection apparatus can be acquired by means of a quantity detection means of the determination device. At least one piece of temperature information relating to a temperature of the water situated in the region of the water meter can be acquired by means of a temperature detection means of the determination device. An evaluation device of the determination device is configured to verify the fulfilment of a save condition, the latter being fulfilled or only being capable of being fulfilled if the quantity information or at least one piece of the quantity information yields that a temperature of the water situated in the region of the water meter corresponds to the temperature of the water present in the water supply network. The evaluation device is further configured to generate and output control commands that effect the storage of the at least one piece of currently acquired temperature information in a data memory if the save condition is fulfilled. By preference, the determination device is the connection apparatus or the water meter. All advantages, features and aspects explained in the context of the method according to the invention are equally transferable to the determination device according to the invention, and vice versa.

Other features which are considered as characteristic for the invention are set forth in the appended claims.

Although the invention is illustrated and described herein as embodied in a method for determining the temperature of the water present in a water supply network, and a determination device for determining such a temperature, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic illustration of a determination device according to the invention in accordance with one exemplary embodiment, configured as a connection device or as a water meter;

FIG. 2 is a detailed, schematic illustration of the water meter from FIG. 1;

FIG. 3 is a flowchart showing a method according to the invention in accordance with one exemplary embodiment, which is performed on the basis of the determination device in FIGS. 1 and 2; and

FIG. 4 is a diagram illustrating a data record collected when the method explained on the basis of FIG. 3 is performed.

### DETAILED DESCRIPTION OF THE INVENTION

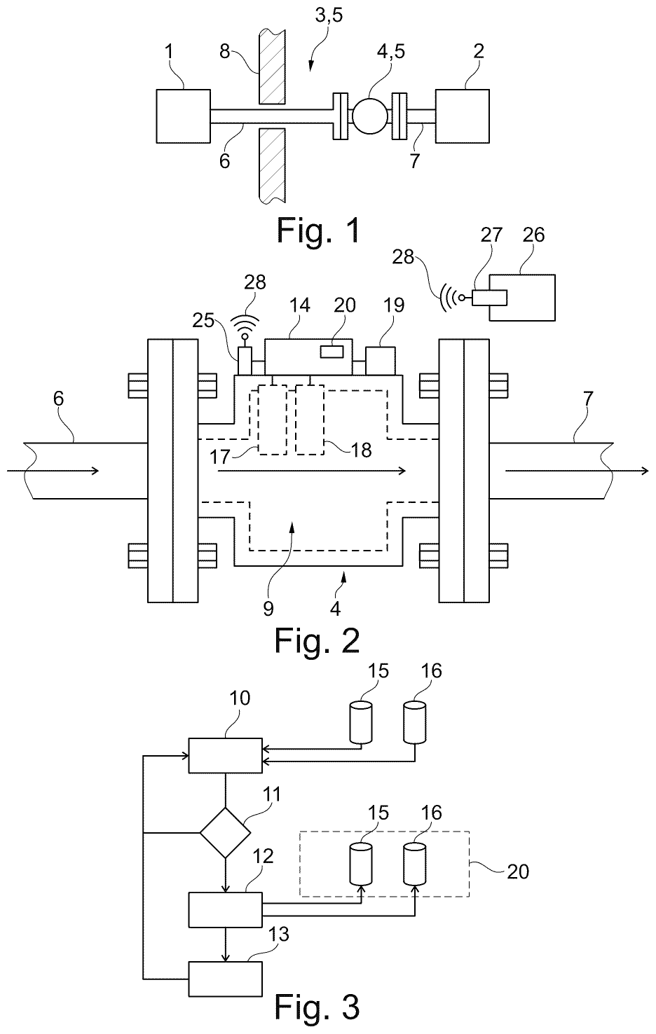

Referring now to the figures of the drawings in detail and first, particularly to FIG. 1 thereof, there is shown a schematic diagram of a connection apparatus 3 containing a water meter 4 and connecting a water supply network 1 to a point of consumption 2. Both the connection apparatus 3 and the water meter 4 in each case realize a determination device 5 according to the invention in accordance with an exemplary embodiment since the water meter 4, and consequently also the connection apparatus 3 which sometimes contains the water meter 4, have all the features essential to the present invention. The water supply network 1 is connected to the point of consumption 2 via pipes 6, 7 of the connection apparatus 3 and via the water meter 4. The pipe 6 connecting the water supply network 1 to the water meter 4 runs through an external wall 8 of a building. Further components of the connection apparatus 3, for instance an extension spindle provided at the water supply network 1 and stopcocks and the like, are not shown in FIG. 1 for reasons of clarity. FIG. 2 shows details of the water meter 4, with the direction of flow of the water drawn from the water supply network 1 and supplied to the point of consumption 2 in the process being indicated by arrows. A quantity of the water drawn from the water supply network 1 to the point of consumption 2 is determined by means of the water meter 4, with this water passing through a measuring chamber 9 for this purpose.

The present invention relates to the determination of a temperature of the water present in the region of the water supply network 1, to be performed by means of the determination device 5. A problem arising in the process is that the water situated in the determination device 5, by means of which this temperature determination is performed, is located in the building. Specifically, the water situated in the measuring chamber 9 is provided to this end. By contrast, the water supply network 1 is situated outside of the building, and so the water present there typically has a lower temperature than the water situated in the measuring chamber 9. These circumstances that make measuring the temperature of the water in the water supply network 1 by means of components of the determination device 5 or of the water meter 4 complicated and the problems resulting from this are overcome within the scope of the present invention.

With additional reference to FIGS. 1 and 2, a method according to the invention in accordance with one exemplary embodiment is explained on the basis of FIG. 3, with FIG. 3 showing a flowchart in this respect. This method contains the steps 10 to 13, with an evaluation device 14 of the water meter 4 being designed and configured to perform these steps, provided the explanations given below do not deviate therefrom. The evaluation device 14 may also be a component of the connection apparatus 3 that is separate from the water meter 4, with only the connection apparatus 3 and not the water meter 4 forming the determination device 5 according to the invention in this case.

In the first step 10, a piece of quantity information 15 and a piece of temperature information 16 are acquired respectively by means of a quantity detection means 17 and a temperature detection means 18. The detection means 17, 18 connected to the evaluation device 14 are each part of the water meter 4. For this purpose, the detection means 17, 18 acquire the measurement values relating to the respective information 15, 16, which are output to the evaluation device 14. The pieces of information 15, 16 are preferably acquired cyclically, for example in increments of two seconds.

The quantity information 15 is ascertained by means of the quantity detection means 17. The quantity detection means 17 is a measurement means that allows the output of appropriate measurement signals which are output to the evaluation device 14 for evaluation purposes. For instance, the water meter 4 may be designed as an impeller water meter with an impeller that rotates on the basis of the flow rate, as a volume meter with fixed or movable measuring chamber separating walls or as an ultrasonic meter with a unit for generating ultrasonic beams that are emitted into the water, with details in respect of the quantity detection means 17 being sufficiently well known to a person skilled in the art, and consequently not being intended to be explained in detail here. Specifically, the quantity information 15 is directed to a flow rate or flow quantity of the water through the measuring chamber 9 and specifies the amount or volume of water that has flown through the measuring chamber 9 during the current measurement interval, which has a length of two seconds. The quantity information 15 is also processed by the evaluation device 14 for billing purposes. Thus, in particular, the overall amount of water drawn during a current readout cycle is determined and is displayed or output by means of an output device 19 of the water meter 4 designed as a display and is stored in a data memory 20 of the evaluation device 14 for a subsequent readout of the corresponding consumption data.

The temperature information 16 is ascertained by means of the temperature detection means 18. The temperature detection means 18 is a measurement means that allows the output of appropriate measurement signals which are output to the evaluation device 14 for evaluation purposes. The temperature detection means 18 realizes a thermometer unit, which projects into the measuring chamber 9. The part of the temperature detection means projecting into the measuring chamber 9 contains a measuring element, the electrical conductivity of which depends on the temperature of the water that is arranged in the measuring chamber 9 and consequently in thermal contact with the measuring element. To this end, measurement signals that depend on the conductivity are generated and output to the evaluation device 19, with the evaluation device 19 in turn determining the temperature of the water in the measuring chamber 9, which represents the respective temperature information 16, by means of these measurement signals. Specifically, the temperature information 16 specifies the temperature in ° C. of the water currently situated in the measuring chamber 9. Just like the acquisition of the quantity information 15, the temperature information 16 is acquired cyclically at an interval of two seconds.

In the second step 11 of the method, the evaluation device 14 is used to verify the fulfilment of a save condition, which depends on the quantity information 15. The save condition is fulfilled if the quantity information 15 yields that the temperature of the water situated in the region of the determination device 5, i.e. the temperature of the water that is in contact with the temperature detection means 18 and consequently situated within the measuring chamber 9, at least substantially corresponds to the temperature of the water situated in the water supply network 1.

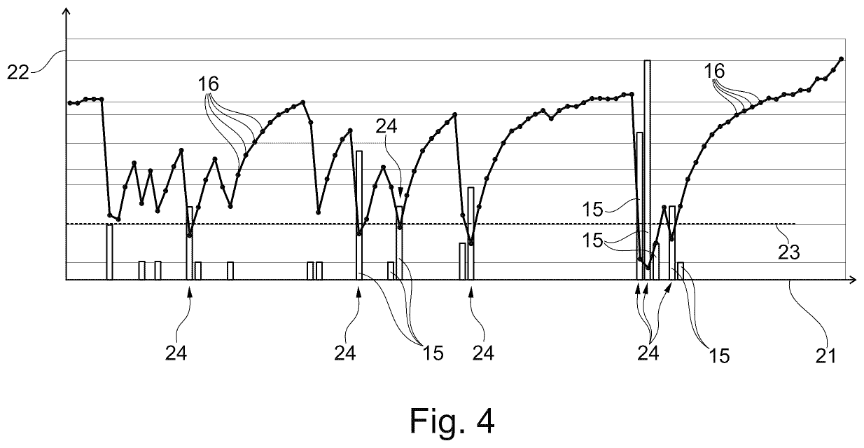

Specifically, the save condition is fulfilled if the quantity information 15 yields that an amount of water that has passed through the connection apparatus 3 or the water meter 4 within a current time interval, which corresponds to the measurement interval of two seconds by way of example, is greater than a predetermined, fixed limit value 23 (see FIG. 4). The limit value 23 is sufficiently large such that the water situated in the measuring chamber 9 at least substantially has the same temperature as the water situated in the water supply network 1 since the water situated in the measuring chamber 9 was still situated in the water supply network 1 immediately prior on account of the flow of the water through the connection apparatus 3, and no noteworthy heating could take place. Specifically, a value at least corresponding to the amount of water present in the water meter 4 or the measuring chamber 9 and in the components of the connection apparatus 3 arranged upstream of the water meter 4 is chosen as the limit value 23. Consequently and by way of example, the limit value in the present exemplary embodiment corresponds to the amount of water of the water present in the pipe 6 and in a connection component (not shown in the figures) used to connect the connection apparatus 3 to the water supply network 1, or the limit value depends on this amount of water. By way of example, the limit value 23 is twice this amount of water in the present case.

For a better understanding of the save condition, reference is made to FIG. 4, which shows a coordinate system with possible, exemplary data points or values for the pieces of information 15, 16. The abscissa axis 21 relates to time and the ordinate axis 22 relates to the values of the pieces of information 15, 16. The values for the quantity information 15 are represented by a bar chart. The values for the temperature information 16 are represented by a scatter plot, in which the points are connected by means of lines. Furthermore, the limit value 23 decisive for the fulfilment of the save condition is plotted as a horizontal line.

Moreover, the relationship between the quantity information 15 and the temperature information 16 also becomes evident from the graph shown in FIG. 4. Starting from the ordinate axis 22 and going to the right, it is evident in respect of the first five values for the temperature information 16 that the values are substantially constant. This temperature corresponds to the temperature of the room in the building in which the water meter 4 is situated. During this time, the quantity information 15 yields that no water is drawn on the part of the point of consumption 2, leading to the constancy of the temperature information 16 during this time.

Once again starting from the ordinate axis 22 and going to the right, a certain amount of water is drawn on the part of the point of consumption 2 between the fifth and sixth measurement points that relate to the temperature information 16, but the amount of water is slightly less than the limit value 23. Even though the save condition is not fulfilled at this time, the course of the temperature information 16 in this region shows a significant drop in the temperature of the water situated in the measuring chamber 9 since the water flows in from the water supply network 1, in which the temperature of the water is correspondingly low. The temperature of the water in the measuring chamber 9 subsequently rises in accordance with Newton's law of cooling, with renewed drawing on the part of the point of consumption 2 leading to further points or times at which there is a drop in the value for the temperature information 16. The limit value 23 is exceeded at the fourth bar for the quantity information 15, as counted towards the right starting from the ordinate axis 22, and this brings about a corresponding drop in the values for the temperature information 16. The save condition is fulfilled at this time 24, and so the assumption can be made that the acquired value for the temperature information 16 reflects the temperature present in the water supply network 1. All eight times 24 at which the save condition is fulfilled are marked appropriately in the diagram.

Provided the save condition has not been fulfilled, the method is continued in the first step 10 with the renewed acquisition and consequent updating of the pieces of information 15, 16. Provided the save condition has been fulfilled, the respective pieces of currently available information 15, 16 and the associated time are stored in the data memory 20 of the evaluation device 14 in the next step 12. In this case, it is possible as a matter of principle for the last values stored when the save condition was fulfilled to be overwritten. However, such overwriting is not envisaged in the present exemplary embodiment, and so the values for the time and the pieces of information 15, 16 stored in the data memory 20 form a data record representing a time series. In relation to the time period shown in FIG. 4, this time series consequently contains eight data points, with each of these data points having three values, specifically relating to the respective time, the associated quantity information 15 and the associated temperature information 16.

In the next step 13 there is a cyclical readout process, in which the corresponding data record is read or called on the part of the supplier. This readout process is implemented monthly, for example, with the respectively read data record being deleted from the data memory 20 in the process (however, deletion is not mandatory). Referring to FIG. 2 again, the water meter 4 contains a connection-side transmission device 25. Furthermore, the readout process is implemented by virtue of a reader 26 with a user-side or supplier-side transmission device 27 being brought into the vicinity of the water meter 4 or of the connection-side transmission device 25, with a wireless communications link 28 being formed between the connection-side transmission device 25 and the supplier-side transmission device 27. The communications link 28 is used to transmit the data record that is stored in the data memory 20 and relates to the time and the information 15, 16 in addition to the aforementioned consumption data.

The data in respect of the information 16, 17 and the respective associated time, transmitted within the scope of step 13, are used within the scope of verifying the adherence to an admissible maximum temperature in the water supply network 1. Specifically, it is verified whether the available pieces of temperature information 16 make it clear that an admissible maximum temperature of the water in the water supply network 1 has been exceeded. In this context, the respective pieces of available quantity information 15 are also included in addition to the pieces of temperature information 16. Thus, it is in particular also evident on the basis of FIG. 4 that the value for the respective temperature information 16 becomes lower with a higher value for the respective associated quantity information 15. This is due to the fact that the value for the temperature comes ever closer to the temperature in the water supply network 1 with an increasing flow rate. In particular, this behavior arises on account of a hysteresis effect, for instance because a temperature of the housing, which likewise corresponds to the room temperature, also influences the temperature of the water present in the measuring chamber 9. For instance, these circumstances can be taken into consideration by virtue of values relating to the temperature information 16 being associated with an error that is ever greater with smaller values for the respective associated quantity information 15. Alternatively, this systematic influence may also be included in the evaluation, for instance on the basis of a model.

Additionally, attention is drawn to the fact that the acquisition of the temperature information 16 in the present case is used not only for the purpose of verifying the adherence to an admissible maximum temperature in the water supply network 1 but also within the scope of a quantity measurement relating to the overall water consumption, i.e. in the context of determining the consumption data. Thus, in this respect, the insight that the current temperature of the water flowing through the fluid meter 4 has an influence on the density of the water is taken into account, and this should consequently be taken into account when determining the consumption data.

Moreover, the temperature information 16 is used within the scope of realizing a frost protection function. Thus, not only is the current temperature information 16 output to the user by means of the output device 19 but the evaluation device 14 is used to verify the fulfilment of a frost condition on the basis of the respective current temperature information 16. The frost condition is fulfilled if the respective current temperature information 16 yields that the water currently present in the determination device 5 could freeze on account of correspondingly low temperatures. Should the frost condition be fulfilled, the evaluation device 14 is used to output a signal directed to the removal or reduction of this risk. This signal output effects a warning output, for example an acoustic warning output, by way of the output device 19. In addition to that or in an alternative, the signal may be output to a heating device (not depicted in detail in the figures) of the determination device 5 or of the water meter 4 such that the water temperature is increased by means of the heating device.

Additionally, a possible modification to the method explained on the basis of FIG. 3, which is also within the scope of the present invention, is presented below. Thus, it is conceivable that the performance of step 10, i.e. the acquisition of the pieces of information 15, 16, is not followed by the verification of the fulfilment of the save condition but instead followed by the storage of these values in the data memory 20. Consequently, step 11 is initially skipped, and so the data record created in the data memory 20 comprises not only the values for the pieces of information 15, 16 and the respective associated time values present when the save condition is fulfilled but all values acquired in this respect, to be precise independently of the save condition being fulfilled. The created data record is subsequently transmitted to the reader 16 within the scope of step 13, with the verification of the save condition and the filtering out of the values unusable for monitoring the temperature in the water supply network 1, connected therewith, being subsequently implemented on the part of the user or supplier.

The following is a summary list of reference numerals and the corresponding structure used in the above description of the invention:
1 Water supply network
2 Point of consumption
3 Connection apparatus
4 Water meter
5 Determination device
6 Pipe
7 Pipe
8 External wall
9 Measuring chamber
10 Step
11 Step
12 Step
13 Step
14 Evaluation device
15 Quantity information
16 Temperature information
17 Detection means
18 Detection means
19 Output device
20 Data memory
21 Abscissa axis
22 Ordinate axis
23 Limit value
24 Time
25 Transmission device
26 Reader
27 Transmission device
28 Communications link

1. A method for determining a temperature of water present in a water supply network, wherein the water supply network is connected to a point of consumption disposed in a building via a connection apparatus that leads into the building from an outside, wherein the connection apparatus contains a water meter that is disposed in the building, which comprises the steps of:
acquiring at least one piece of quantity information relating to a quantity of water reaching the point of consumption via the connection apparatus by means of a quantity detection means of the water meter;
acquiring at least one piece of temperature information relating to temperature of the water situated in a region of the water meter by means of a temperature detection means; and
verifying a fulfilment of a save condition, the save condition being fulfilled or only being capable of being fulfilled if quantity information or the at least one piece of quantity information yields that the temperature of the water situated in the region of the water meter corresponds to the temperature of the water present in the water supply network, wherein the at least one piece of temperature information is stored in a data memory and/or used to determine the temperature of the water present in the water supply network in an event of the fulfilment of the save condition.

2. The method according to claim 1, wherein the save condition is fulfilled or only capable of being fulfilled if the quantify information or the at least one piece of quantity information yields that an amount of the water that has passed through the water meter within a current time interval is greater than a predetermined limit value.

3. The method according to claim 2, wherein the predetermined limit value is a fixedly predetermined value.

4. The method according to claim 1, which further comprises acquiring the at least one piece of quantity information and/or the at least one piece of temperature information at predetermined time intervals.

5. The method according to claim 1, which further comprises storing the at least one piece of current temperature information in an event of the save condition being fulfilled, provided that the at least one piece of temperature information was already stored previously in the data memory.

6. The method according to claim 5, which further comprises storing the at least one piece of quantity information in the data memory in addition to the at least one piece of temperature information.

7. The method according to claim 6, wherein the connection apparatus contains a connection-side transmission device, by means of which a communications link can be established to a user-side transmission device, the method further comprises:
transmitting the at least one piece of temperature information stored in the data memory within a scope of a readout process from the connection apparatus to the user-side transmission device via the communications link.

8. The method according to claim 7, wherein within the scope of the readout process the at least one piece of quantity information, in addition to the at least one piece of temperature information, is transmitted from the connection apparatus to the user-side transmission device via the communications link.

9. The method according to claim 7, which further comprises establishing a wireless communications link as the communications link.

10. The method according to claim 6, wherein the connection apparatus contains an output device, the method further comprises:
outputting a piece of stored temperature information or pieces of stored temperature information stored in the data memory.

11. The method according to claim 1, wherein the at least one piece of temperature information is additionally used within a scope of a quantity measurement relating to an overall water consumption and/or in a realization of a frost protection function.

12. The method according to claim 4, wherein the predetermined time intervals are predetermined, constant, time intervals.

13. The method according to claim 7, wherein the water meter contains the connection-side transmission device.

14. The method according to claim 10, wherein the water meter contains the output device.

15. A determination device for determining a temperature of water present in a water supply network, wherein the water supply network is connected to a point of consumption disposed in a building via a connection apparatus that leads into the building from an outside, the determination device comprising:
a water meter for the connection apparatus which is disposed in the building;
a quantity detection means, wherein at least one piece of quantity information relating to a quantity of the water reaching the point of consumption via the connection apparatus is acquired by means of said quantity detection means;
a temperature detection means, wherein at least one piece of temperature information relating to the temperature of the water situated in a region of the water meter is acquired by means of said temperature detection means;
a data memory; and
an evaluation device configured to verify a fulfilment of a save condition, the save condition being fulfilled or only being capable of being fulfilled if quantity information or at least one piece of the quantity information yields that the temperature of the water situated in the region of the water meter corresponds to the temperature of the water present in the water supply network, wherein said evaluation device is further configured to generate and output control commands that effect a storage of the at least one piece of temperature information in said data memory if the save condition is fulfilled.
